(19) United States
(12) Patent Application Publication
(10) Pub. No.: US 2001/0053997 A1
(43) Pub. Date: Dec. 20, 2001

(54) System for click through contest voting via commissions

(76) Inventor: David Bain, Arlington, VA (US)

Correspondence Address: BLACKMON IPS & LAW OFFICE, 2101 CRYSTAL PLAZA ARCADE , PMB #289, ARLINGTON, VA, 22202, US

(21) Appl. No.: 09/757,424

(22) Filed: Jan. 11, 2001

Related U.S. Application Data
(60) Provisional application No. 60/185,100, filed on Feb. 25, 2000.

(51) Int. Cl. G06F 17/60

(52) U.S. Cl. 705/14

(57) ABSTRACT

A network and system for acting as an information collection service or a polling service by allowing the purchaser to select the recipient of the commission. In a preferred embodiment the user can select from at least one non-profit organization among the selections resulting in a tax deductible gift. By tracking the user selections through the assignment of commissions, the system can keep track of the preferences of users. In a further extension of this invention, the commission system can be used as a proxy for calculating votes of users for certain organizations or causes or other entities or even principals represented by crediting the commission or vote to particular organizations, causes, or ideas. The votes can be tabulated in a contest fashion to calculate a winning person, organization, cause or idea. The length of time which users will be allowed to vote can be controlled by the site dependent on time, total money or votes tabulated, or other criteria.

### BACKGROUND OF THE INVENTION

1. Field of the Invention

The present invention relates to a network and system for registering user preferences on a website through a commission crediting system and a method of running a contest thereby.

2. Description of the Prior Art

It is well known to purchase goods and services over the Internet. A buyer connected to a website through a browser can select goods through one click purchasing or other check out methods and pay for the goods using a credit card. The goods are then shipped or delivered electronically to the buyer to complete the transaction.

It is also known on the web to credit a referring site or agent with a commission for the goods purchased on the web. Analogous to paying a salesclerk in a physical store, a person, agent, or referring site can be credited with causing the user to select the particular goods or particular site when purchasing the goods, and as a reward the sales site pays a certain percentage or amount to the person, agent or referring site to encourage further sales by similar methods.

The network and system according to the present invention takes the commission process a step further to act as an information collection service or a polling service by allowing the purchaser to select the recipient of the commission. In a preferred embodiment the user can select from at least one non-profit organization among the selections resulting in a tax deductible gift. By tracking the user selections through the assignment of commissions, the system can keep track of the preferences of users.

In a further extension of this invention, the commission system can be used as a proxy for calculating votes of users for certain organizations or causes or other entities or even principals represented by crediting the commission or vote to particular organizations, causes, or ideas. The votes can be tabulated in a contest fashion to calculate a winning person, organization, cause or idea. The length of time which users will be allowed to vote can be controlled by the site dependent on time, total money or votes tabulated, or other criteria.

None of the above inventions and patents, taken either singly or in combination, is seen to describe the instant invention as claimed.

### SUMMARY OF THE INVENTION

Accordingly, it is a principal object of the invention to provide a network and system for allowing for user selection of where credit or commission for internet sales are to be credited.

It is another object of the invention to provide a network and system for allowing vendors to register their sites to link the voting buyers with sites willing to pay commissions according to the preferences of the buyers.

It is a further object of the invention to provide a network and system which allows users to credit purchase commissions or other credits to particular causes, issues, or ideas as a method of evidencing popular support (“vote”) for the causes, issues, or ideas.

Still another object of the invention is to provide a system and network for allowing credit or commissions to be applied toward an organization or group by voting for the same organization or group when purchasing goods or services.

It is an additional object of this invention to provide a contest in which voters qualify to vote by purchasing goods from a vendor and applying vote credits as a function of the purchase towards a particular selection.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a diagram of a network and system according to a first embodiment of the invention.

Similar reference characters denote corresponding features consistently throughout the attached drawings.

### DETAILED DESCRIPTION OF THE PREFERRED EMBODIMENT(s)

The present invention is to a network and method for running a contest by tracking user preferences and allocating credit, votes, or commission to user specified selections.

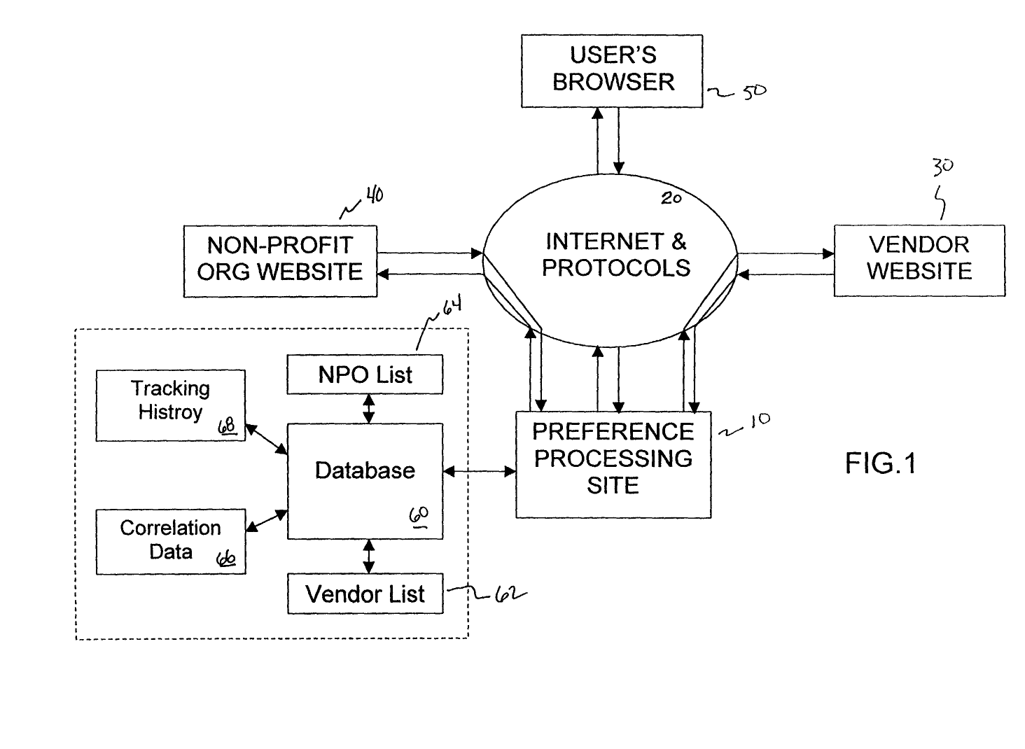

As best shown in FIG. 1, a Preference Processing Site (PPS) 10 operates on a network such as the Internet 20 to utilize the communication and protocol standards allowing multiple users to access the site using various operating systems (DOS, WINDOWS, etc.) and various browsers (NETSCAPE, INTERNET EXPLORER, etc.). Also connected to the Internet are various Vendors 30 and various Non-Profit Organizations (NPO) 40. One skilled in the art would recognize, that it is not necessary for the Vendors or NPOs themselves to be connected as the PPS or another service could track information, sales orders, etc. in place of the vendors or NPOs or the telephone, facsimile or other communication system could be used to connect non-Internet connected parties. However, it is envisioned that the maximum benefits and efficiencies of this system can best be utilized by all parties being connected to the web, and will be explained as if all parties were connected.

In operation, vendors that wish to offer goods for sale through the PPS must register (FIG. 2) their store or site with the PPS. Organizations (non-profit or otherwise), causes, or other entities that want to receive votes, credits, or commissions from the sales through the PPS must also register (FIG. 3). Users who want to shop and have their cause or organization receive credit for their purchases must shop through the PPS and select the recipient for the credit (FIG. 4) or pre-register their preferences (FIG. 5). Internet sites that wish to run a contest to poll particular demographic opinions can establish webpages according to the present invention to allow users to vote on the contest winner by applying credit (“votes”) from purchases towards a selected candidate.

The Internet 20 provides a central connection and protocol system for connecting all of the parties. The PPS provides a central database for collecting information on each of the vendors, organizations, and users who shop through the PPS. Information contained in the database through prior registration system determines and controls the selections available on the network to a later arriving user determining where he can shop and who can receive credit for his purchases. In a second embodiment, described further below, the system can also be used as a system for collecting votes or opinions on issues to provide a lobbying voice to show the opinion of the buying public to add leverage to the voice.

Returning to the present embodiment of the invention, the network will be described in reference to assigning commissions for purchases to organization selected by a user. While the organizations are generally referred to as NPOs (Non-profit organizations) the tax status or entity type of the organization does not affect the operation of the invention, and one skilled in the art will recognize that the use of a NPO is for illustration purposes only.

In order for the PPS to operate effectively, a number of vendors must register with the PPS and be willing to assign commissions, credits, vouchers, or other valuable consideration over to the parties chosen by a purchaser. The number of vendors who register with the site will impact the value of the site, such that the greater number of vendor choices available to a purchaser through the site, the more likely that a purchaser will go through the site to purchase goods. However, the site can work effectively with only one vendor registered. The operation of the site will be explained with reference to one representative vendor, but it is to be understood that more vendors can register in a similar fashion and will operate in an analogous manner to the described vendor.

Before registering, the Vendor and the PPS must negotiate a contract to split profits or otherwise confer credits or other valuable consideration to those parties designated by the PPS. Depending on the relative size of the PPS, this contract can be a standard contract or according to the individually negotiated terms between the parties. The negotiation can take place in person, over the phone, or by electronic signature over the Internet or other network.

Once the contract is in place, the Vendor can register with the PPS, preferably through the Internet. As shown in FIG. 2, the vendor initiates a vendor registration program 100. As discussed above the vendor can agree to a standard form contract 110 available with the PPS or the contracting can negotiated with the PPS according to unique terms. Once the contract is in place, the Vendor proceeds to signing onto a registration process 120 to register his site with the PPS. An authentication and verification process 130 well known in the field can be used to ascertain information about the vendor and verify the authenticity of the vendor's identification. Alternatively, a password and ID 140 can be provided by the PPS to the Vendor to link the Vendor and the Vendor's computerized profile 150. Once the Vendor has signed onto the network and the Vendor's profile 150 is accessed, the Vendor can edit the profile 150.

In a preferred embodiment, the Vendor provides an address to the Vendor's on-line retail site or to an affiliate site that provides on-line marketing of the Vendor's goods. For those vendors that do not have on-line marketing capability, their goods can be registered with the PPS or a PPS affiliate to provide on-line marketing capability to the Vendor.

The Vendor must then authorize the use of click-through purchasing such that a purchaser hyperlinking from the PPS to the Vendor on-line retail site also transfers appropriate information from the PPS to the Vendor to track the referral site (i.e. the PPS) information as well as the name or address of the party to be credited with the commission. Preferably, the accounting is tracked through a third party commission tracking party (“third party verifier”) with whom the Vendor is also registered. The use of a third party reduces the likelihood of disputes as to the accounting of commissions.

The commissions can be based on sales of a “traditional” sales vendor having goods available for fixed prices, or the sales can be for a dynamic pricing site that uses auctions or other means to determine flexibly priced goods.

As appropriate, the Vendor may be required to install and initiate software which provides the tracking and receives information from the PPS referral site.

In a similar manner, parties that wish to receive commissions from the PPS must also register with the PPS. The sites are preferably non-profit organizations, but the tax status of the organizations (hereinafter “NPO”) has no bearing on the operation of the network. The NPOs register either their site so that purchasers can review information about the NPO, or provide a brief summary of the information on the PPS for review. The NPO must also register either an agent or address to receive the commission check, and their tax identification number along with any other necessary identifying information so that they may be paid. The check may come from the Vendor directly or from the third party verifier at the appropriate time to settle the commissions due to the NPO.

In operation, as best shown in FIG. 1, a potential purchaser (“user”) using his browser 50 connecting to a network such as the internet 20 through a service provider (not shown) in a well known fashion. The purchaser signs onto the Preference Processing Site (PPS) 10 through the browser by entering the address or by otherwise linking to the homepage of the PPS.

The PPS stores in an appropriate database 60 a vendor list 62 of all the available vendors who have registered to make goods available to purchasers and to distribute commissions according to PPS direction. The PPS also stores a list 64 of organizations (NPOs) that have registered to receive credit or commissions and have been approved by the PPS for selection. The database may further contain a correlation table 66 such that certain Vendors 62 are listed according to which NPO 64 is selected or vice versa. The database may further have an internal or external history tracking database 68 for tracking which NPOs 64 or which Vendors 62 are selected or for tracking other data.

Once the user has signed onto the PPS 10, the PPS presents in graphical, text, or menu format a number of NPO selections that the user can choose from to assign commissions or credits from his purchases to benefit the NPO 40. The menu may include a hyperlink to information about the NPO or to a site affiliated with the NPO. Once selected, the PPS can build a profile for the user using a cookie such that if the user signs onto the site, the NPO is pre-selected, or the user may be requested to confirm his selection during each visit.

The PPS also presents a number of Vendors 62 that the purchaser may select from to buy goods or services from. The selection can be made after the NPO selection and send the user directly to the Vendor site or affiliate site offering the Vendor's goods. Alternatively, the user may select the Vendor site, then the NPO selection, and then be forwarded to the Vendor site after all required fields have been answered.

The purchaser 50 then purchases goods or services directly through the linked vendor site (“click-through purchase”). Information sent via a cookie or click-through purchase is tracked by the PPS or affiliate site or the Vendor to track the referral site (PPS) and the commission designee (NPO).

The information tracked by the PPS is then used to tabulate the amount of votes or preferences by users for which NPO they favor. The votes can be correlated to the amount of purchase (“dollars spent”) or the number of visits (“referrals”) or a combination of these numbers. Additionally, weighting factors and specials can be used to encourage consumer behavior and determine the effect of incentives. For example, the PPS could run a special for double credits/commissions for all purchases made after 6pm Pacific Time to assist a site overloaded by mid-day traffic. Or the PPS could assign double commissions for all purchases of shoes from a particular shoe vendor or in conjunction with a reduced price on shoes bought on a particular day.

By tracking the sales data and referrals (“hits”) and correlating them with specials or other incentives, the effect of the incentives on the consumers and on sales can be tracked.

In a further embodiment, the PPS can be used to track public or more importantly the preferences of purchasers linked to their buying power opinion in the form of a contest, election, or poll. As shown in FIG. 3, instead of selecting NPOs, or in addition to selecting NPOs, the purchaser may select a particular cause or issue to vote for. When making purchases, information pertaining to the cause selected by the purchaser is tracked by the PPS. By correlating the amount of purchases, the frequency of shopping or purchases and other consumer information to a certain number of vote credits and applying the vote credits to the cause “selected,” the PPS can match causes to the preferences of purchasers, weighted by the “buying power” of those voting for the cause. This information could be particularly important to persons such as those running for office who wish to support a cause while achieving popular support from those constituents having the buying power or money to contribute to the campaign. The tracking leads to a different kind of credence or authentication or credibility to the choices of an important demographic segment—the purchaser ranked by frequency or amount of purchases or other criteria.

The PPS can also use the votes in the form of a contest. As an example, the an organization interested in awarding a humanitarian award for outstanding contributions to preserving the environment could establish a website according to the present invention. If the award was to be base in whole or in part on public opinion, then the PPS could poll the votes for the contest. The candidates being considered for the award would be listed on the PPS in place of the NPO's of FIG. 1. A user would select the candidate that he wanted his vote credits to go to as explained above. The user would then make purchases through the PPS as explained above. Vote credits as a function of site visits to vendors and purchases made would be applied to the chosen candidate. The contest could run until a certain amount of votes were cast to one candidate or were cast for any candidate, until a certain amount of commission or sales were made, or other criteria.

Unlike polls or other opinion taking devices which must factor in a high percentage error variance for those who are not taking the poll seriously, by counting only the votes of purchasers ranked by the money behind the vote, the accuracy of the voting should be increased by discouraging non-serious parties. Additionally, there could be an incentive for those wishing to show support for a cause to spend additional money to “enhance” his opinion, working to the benefit of the Vendors and the cause.

Additional incentives could be provided to the causes to encourage that they sign up on the PPS or to provide charitable contributions to the causes. This can take the form of either assigning the commission to the cause or a hybrid of incentives and awards.

It is to be understood that the present invention is not limited to the sole embodiment described above, but encompasses any and all embodiments within the scope of the following claims.

I claim:

1. A network for conducting a contest based on commissions, wherein users can select the recipient of commissions or voted credits from one-click purchases to determine the winner of the contest.
